(19) United States
(12) Patent Application Publication
(10) Pub. No.: US 2010/0005413 A1
(43) Pub. Date: Jan. 7, 2010

(54) User Interface for Individualized Education

(76) Inventors: Changnian Liang, Shanghai (CN); Yuan Li, ShenZhen (CN)

Correspondence Address: LEE & HAYES, PLLC, 601 W. RIVERSIDE AVENUE, SUITE 1400, SPOKANE, WA, 99201, US

(21) Appl. No.: 12/168,777

(22) Filed: Jul. 7, 2008

(51) Int. Cl. G06F 3/048

(52) U.S. Cl. 715/781

(57) ABSTRACT

A graphical user interface is used in a computer-based learning system which uses knowledge points organized with a predefined multilevel arrangement. A graphical window which has selectable elements of multiple levels is used for navigation in choosing a knowledge point to be studied. Upon selection, the graphical window displays in information display area an information content associated with the chosen knowledge point for the user to study and provide a feedback such as answers. Upon receiving the user feedback through a user interaction element, the graphical window displays an evaluation result of the user feedback. Additional selectable elements are used to choose the type of information content (such as knowledge content and evaluation content) to be displayed. The graphical user interface also uses additional graphical windows for user inquiry and reviews and for displaying study statistics.

### RELATED APPLICATIONS

This application is related to U.S. patent application Ser. No. 12/121,249, filed on May 15, 2008, entitled “Differentiated, Integrated and Individualized Education”, which application is hereby incorporated by reference in its entirety. This application is also related to Chinese patent application no. 200810040255.5, filed Jul. 7, 2008, entitled “USER INTERFACE FOR INDIVIDUALIZED EDUCATION”.

### TECHNICAL FIELD

This disclosure relates to the field of computer systems, and particularly computer-based learning systems and methods for individualized learning.

### BACKGROUND

As Internet becomes widely popular, multiple Internet-based education systems emerge. These Internet-based education systems are usually based on a website which provides knowledge contents to users. The knowledge contents are either simply listed as information or organized according to conventional education systems such as school grades and related curriculums. There is no coherent organization of knowledge that is functionally designed to take advantage of the modern computer technologies, particularly the power of Internet. The utilization of Internet in the existing Internet-based education systems is limited to the convenience of access only, which is dominantly a feature of the primitive Internet, the so-called Web 1.0, but not for taking advantage of the rapidly developing computer systems and Internet technologies.

Conventional teaching materials, such as teaching programs, teaching curriculums, courses, training programs and training syllabus, even if comprehensively implemented on the Internet to be made easily accessible by users, still fall far short of the promises of the growing revolution of the second-generation Internet, Web 2.0. First, these teaching materials, and the system and methods that come along with them, cannot provide true individualized learning. Second, they do not adequately promote user-to-user (peer-to-peer) interaction. Third, they do not take advantage of the dynamic nature of an Internet-based computer system. Fourth, they do not take advantage of the collective intelligence and automatic self-learning power of an Internet-based computer system.

For example, in a typical education website, each time a user logs onto the website, a fixed webpage appears first, which allows the user select a particular learning content, do some reading, and do some exercises or take a test. One problem with such design is that the education system usually provides disconnected or random study subjects, or static knowledge content, and is thus unsuitable for achieving efficient studies by students of various levels and various learning abilities. As a whole, the learning may be either a casual ad hoc learning of separate (or even random) topics, or a rigid course study following a fixed curriculum pre-prescribed by the system. In general, the existing education systems also require guidance or instructions of an instructor (e.g., a parent or teacher) in order for the learning process to continue. In addition, if the learning content for the user is continuous from the previous one, the user need to recall the previously studied learning content and go back to the end of last learning content in each login. This not only wastes the time of the user, but also leads to a greatly diminished user experience.

Furthermore, in existing Internet-based education systems, the learning history of the user is normally not recorded, much less analyzed and organized by the system to improve learning. The fixed knowledge content and teaching method thus do not consider the actual learning process of each individual, and further do not allow user feedback to the system except for answering questions or finishing assigned exercises, tests or homework. As a result, active user participation is greatly limited. In addition, due to the lack of learning history information, the existing education websites are incapable to identify the weak points of a student's knowledge and learning to achieve focused improvement.

As a result, learning efficiency in existing education systems often falls far short of the potential of an individual. These education systems are characterized by rigid contents and generic (versus individualized or personalized) tests, and inflexible user interface and mechanical presentation. This not only leads to waste of resources but also results in discouragement, fatigue, tiredness and boredom of people who are trying to learn. Such are characteristics of a rigid teaching system with fixed materials, fixed standard, and fix communication channel.

Although some education websites attempt to counter some of these problems by offering a certain level of customization, such as a slightly different teaching material for each individual, the concept of the present online education is still largely built on the conventional concept of using static curriculums to teach a pre-formulated class or grade, and thus still fall short of the promise of Web 2.0. Changes to the conventional concept have been limited to external modifications rather than fundamental reconstruction. The existing learning systems, including the Internet-based ones, thus fall into a suppressing mode in which the student is forced to optimize his or her learning to adapt to the system, rather than a flexible supportive system that automatically adapts to the student with an aim to teach the student to his or her unique and highest potential.

### SUMMARY

This document describes a learning system based on differentiated and structured knowledge points which are organized in a predefined multilayer arrangement. The predefined multilayer arrangement of the knowledge points has a structure that is pertinent to the particular nature of the subject matter to be studied, and is systematically defined with fine differentiation of the knowledge points suited for Internet-based learning. Each knowledge point has an information set which may include a knowledge content, an evaluation content and a solution content. For a given knowledge point, the learning system uses an interactive user interface to provide an associated knowledge content and evaluation content, analyzes the user's answers to the evaluation content and determines a next knowledge content and evaluation content to be provided for study. The learning system may also determine the next knowledge point to be studied by the user based on the user's answers and the predefined multilevel arrangement of the knowledge points. Because each user may have unique user feedback and user selections (depending on the study interest, knowledge level and learning capabilities of the user), the learning system thus provides different learning courses for different users to achieve individualized learning.

One aspect of the disclosure is a graphical user interface used in the learning system for the user to interact with the learning system during studies. The graphical user interface has a graphical window which has selectable elements of multiple levels used for navigation in choosing a knowledge point to be studied. The graphical user interface has a plurality of first-level selectable elements each representing a respective one of a plurality of first-level knowledge points of a learning subject. A plurality of sublevel selectable elements is invoked by selecting one of the first-level selectable elements. The plurality of sublevel selectable elements each represents at least one sublevel knowledge point related to the first-level knowledge point represented by the first-level selectable element currently selected by the user. The sublevel knowledge point is determined based on the first-level knowledge point according to the predefined multilevel arrangement of knowledge points

Upon selection, the graphical window displays in information display area an information content associated with the chosen knowledge point for the user to study and provide a feedback such as answers. Upon receiving the user feedback through a user interaction element, the graphical window displays an evaluation result of the user feedback.

In some embodiments, additional selectable elements are used to choose the type of information content (such as knowledge content and evaluation content) to be displayed. In some embodiments, the graphical user interface also uses additional graphical windows for user inquiry and reviews and for displaying study statistics.

Another aspect of the disclosure is a computer implemented learning method. The method stores a predefined multilevel arrangement of knowledge points of a learning subject, generates a user interface described above, and receives through the user interface a user feedback to the information content displayed in the information display area.

Another aspect of this disclosure is a computer-based learning system which has a processing unit and a memory including computer program instructions executable by the processor unit to store a predefined multilevel arrangement of knowledge points of a learning subject; generate a user interface described above; and receive through the user interface a user feedback to the information content displayed in the information display area.

Combined with the predefined multilevel arrangement of knowledge points, the method and the system described in this disclosure provide a different learning course for different users. The study content and the evaluation content may vary from user to user, thus realizing individualized study. At the same time, the learning system may also record the learning history of each user to facilitate reviews by user at any time and to help determine the next knowledge point to be studied.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF DRAWINGS

The detailed description is described with reference to the accompanying figures. In the figures, the left-most digit(s) of a reference number identifies the figure in which the reference number first appears. The use of the same reference numbers in different figures indicates similar or identical items.

FIG. 1 illustrates an exemplary architecture of a computer-based learning system in accordance with the present disclosure.

FIG. 2 illustrates an exemplary tree structure of knowledge points in Mathematics in accordance with the learning system of the present disclosure.

FIGS. 3A-3C illustrate exemplary primary user interfaces of the above-described learning system.

FIGS. 4A-4E illustrate exemplary secondary user interfaces of the learning system for user inquiry and user review.

FIG. 5 illustrates an exemplary secondary user interface of the learning system for demonstrating a user learning profile.

FIG. 6 is a flowchart of an exemplary method using the learning system to render the user interface and provide user learning.

### DETAILED DESCRIPTION

Prior to describing the exemplary embodiments of user interface used in the learning system, this disclosure first explains some of the technical terms used herein.

Knowledge point: a knowledge point is a cognitive element of a body of knowledge, such as a branch of science, a combination of several related sciences, an educational course, or any subject of learning. According to the laws of human cognition and specific applications of the knowledge, knowledge of a subject is differentiated into multiple knowledge points. Such differentiation is usually multilayered and may reach the most elemental knowledge points, beyond which further differentiation is no longer practical or helpful for the learning purpose. For instance, arithmetic, a subject of entry-level Mathematics, can be differentiated into multiple first-level knowledge points such as “Numbers”, “Calculations”, “Measures”, “Applications” (or “Word Problems”) and “Geometry” (or “Shapes”). The first-level knowledge point “Numbers” can be further differentiated into several second-level knowledge points such as “Concept of Numbers”, “Integers”, “Decimals”, “Fractions”, “Divisions”, “Fraction and Percentage” and “Ratio and Proportion”. By the same token, each second-level knowledge point may be further differentiated into multiple third level knowledge points.

Knowledge content: a knowledge content is a description of the concepts related to one or more knowledge points. Alternatively or additionally, the knowledge content is a description of how to apply the knowledge of a knowledge point. A knowledge content may be embodied in various forms including text, graphics and images (static or animated), audio, video (including flash video) and multimedia. A knowledge content is usually instructional and akin to teaching materials. For example, a knowledge content may be similar to the content of a topic in a traditional teaching curriculum or a description of a topic adopted in the textbook. In the present disclosure, a knowledge content may be either system-provided (e.g., pre-written by experts and stored in the learning system) or user-provided, as described herein. In some embodiments, at least some of the knowledge contents of the knowledge points are system-provided and pre-stored in the computer-based learning system. Some of the knowledge contents of the knowledge points may be user-provided.

Evaluation content: an evaluation content in this description may refer to a material used for various purposes including evaluation, diagnosis and user practices, and may include exercises, quiz questions and comprehensive evaluation questions designed with respect to one or more knowledge points. An evaluation content may or may not include answers to the exercises and questions. Evaluation contents may be carefully selected and arranged in order to efficiently help users to learn the knowledge content by maximizing study efficiency and avoiding burying students with an excessive number of tests and problems. Answers may include the final answers to the questions in the evaluation content and may also include the work processes that lead to the correct answers. An evaluation content and answers may be embodied in various forms including text, graphics and images (static or animated), audio, video and multimedia.

Solution content: a solution content in this description may refer to any information that contains an answer or a solution to an evaluation content. A solution content may contain a single or multiple answers.

User feedback: a user feedback in this description in general refers to a feedback by the user with respect to an information content. For example, if the information content is an evaluation content including a question, the user feedback may be an answer to the question provided by the user. In other situations, user feedback may be a user comment on the information content. For example, a user may comment on the quality of certain knowledge content, evaluation content or solution content.

Predefined multilevel arrangement: a predefined multilevel arrangement is an organizational structure of multiple knowledge points of a certain subject or a combination of subjects to be learned by a user. The knowledge points are organized according to the degrees of advancement and complexity of the knowledge points and inter-relations among them. A predefined multilevel arrangement of knowledge points is typically designed (e.g., by experts) before the learning system can be used, and is stored in the system, but can be modified anytime. A predefined multilevel arrangement of knowledge of points may include one or a combination of various types of topologies such as a tree structure, a pyramidal structure, a star structure, a chain structure, a ring structure and a grid structure. The predefined multilevel arrangement defines inter-relations of the knowledge points. Furthermore, each knowledge point may be accompanied with indicative information of that knowledge point to define inter-relations of the knowledge points, such as progressive levels, preparatory relations and prerequisites, as described herein.

It is appreciated that the predefined multilevel arrangement of the learning system may contain multiple groups of knowledge points. The multiple groups may or may not be related to each other. The multiple groups of knowledge points may relate to each other to a larger group. For example, the learning system may have knowledge points for multiple subject matters to be studied, of which the knowledge points of each subject matter are grouped into separate groups according to their respective levels of difficulty. As a user has finished the knowledge points of a certain group, the learning system may suggest the student to move on to another group of knowledge points which are at a higher level. For example, the levels of difficulty may be identified as grades as in the traditional school curriculums. The knowledge points of a subject matter, such as math, are grouped into several grades. When the user has finished the group of knowledge points representing the first grade math, the learning system may suggest the user to study the group of knowledge points representing the second grade math.

Information set: an information set is a set of information associated with one or more knowledge points and may each include at least one information content which may be a knowledge content, an evaluation content, a solution content or a user information content (such as present information and learning history information).

Information content: an information content may be a knowledge content, an evaluation content, a solution content or a user information content (such as personal information and learning history information). Multiple information contents of different kinds may be included in an information set.

Learning system: a learning system as described herein includes multiple knowledge points (which are organized in a predefined multilevel arrangement), and information sets associated with the multiple knowledge points. The predefined multilevel arrangement of the multiple knowledge points may be adjusted. The information sets may each include an information content such as a knowledge content, an evaluation content and a solution content. The learning system receives a user input through a user terminal and provides feedback to the user. The user terminal interacts with the learning system but may or may not be a part of the learning system. A learning system may be implemented as a website (on a network server, for example) which can be accessed from a user terminal (such as a personal computer or a portable device). Alternatively, learning system may be stored in the user terminal, and optionally updated periodically from a server through the Internet. The functions of a learning system can be implemented by software, hardware or a combination thereof.

Learning history: learning history is information of the user's learning process. Such information may include any information related to the users learning process, including knowledge points selected by the user to study in the past, a track of such selected knowledge points, the user's feedback to the selected knowledge points, and the speed of the user feedback (which are related to the times the user needed to answer each question, the times the user needed to complete the study of each knowledge point, and the total times the user needed to complete a certain subject or a set of related subjects). The user feedback may include not only the feedback itself (such as answers) but also statistical information of the user's studies, such as completion rate, and correct rate.

Study result/Evaluation result: a study result or an evaluation result is an evaluation of the results or effects of a user's study. A study result may be a measure of the quality of the user response, measured in various terms such as a scoring of the correct answers, the speed of the user feedback (which are related to the time the user needed to answer each question and the time the user needed to complete the study of the knowledge point), and the level of completion (e.g., what percentage of the work did the user complete). A study result may be that of a particular knowledge point, or of a series of knowledge points. A study result may be that of a particular learning session or an accumulated result of a particular user within a certain period of time, such as a total study result accumulated from the beginning when the user started to use the learning system.

For example, the study result of a knowledge point is an evaluation by the learning system of how well the user has learned the knowledge point based on the user feedback to the evaluation content associated with the knowledge point. The evaluation may consider both the correctness of answers and the speed of the feedback. One exemplary form of a study result is a grade (such as unsatisfactory, satisfactory, good, and excellent). In some embodiments where the evaluation content of a knowledge point have test questions or exercise questions, the study result may be a quantified score or grade, such as a percentage score calculated based on correct answers.

User information: user information generally refers to information related to a user including personal information such as geographic location, age, gender, school grade level, and parent information (e.g., occupation, education, and age of parents).

### The Learning System

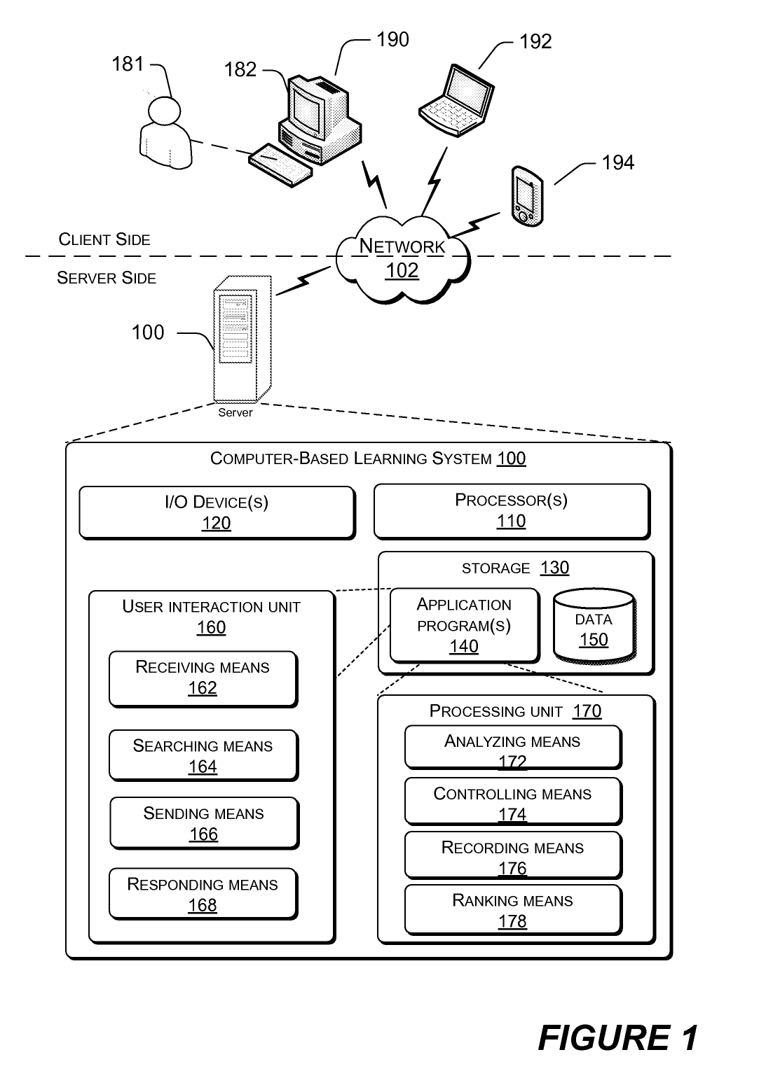

FIG. 1 illustrates an exemplary architecture of a computer-based learning system in accordance with the present disclosure. The computer-based learning system 100 is used to carry out the learning processes including rendering of the user interface described in this disclosure. The learning system 100 is implemented as a server computer or a cluster of server computers. Computer-based learning system 100 is shown to be connected through network 102 to multiple user devices (client computing devices) 190, 192 and 194 to provide learning service to users such as user 181 which accesses the learning system through terminal 182.

It is noted that, the terms “computer” as used in this document should be broadly understood to include any device that has computing capability, and is not limited to a PC, a server, or a computing device based on PC or server. A client computing device (190, 192 and 194) is not limited to a personal computer, but may be any kind of an electronic device suited as a user device used for learning in connection to the learning system 100. Each client computing device 190, 192 and 194 may also have its own processor, I/O devices and a storage or memory.

Illustrated network 102 represents any one or combination of multiple different types of networks, such as the Internet, LAN, WAN, DSL networks, cable networks, and wireless networks. For the purpose of illustration, the network 102 is divided into a client side and server side. The core of the computer-based learning system 100 is on the server side. Although devices on the client side may also be understood as an extension of the learning system 100, they are generally not considered part of the learning system 100 in this exemplary implementation.

Computer-based learning system 100 includes basic components of a computing device such as processor(s) 110, I/O devices 120 (which may include a network interface), and storage 130. The storage 130 stores application program modules 140 and data 150. Data 150 may include databases containing knowledge points organized with a predefined multilevel arrangement and the associated information sets. Each information set includes one or more of a knowledge content, an evaluation content and a solution content. Data 150 may also include user information and study results.

It is appreciated that the storage 130 may be any form of computer readable media, or any suitable storage or memory devices for storing computer data, either permanently or temporarily. Such memory devices include, but not limited to, hard disks, flash memory devices, optical data storages, and floppy disks. Furthermore, the computer readable media (e.g., storage 130) containing the computer-executable instructions may consist of component(s) in a local system or components distributed over a network of multiple remote systems. The data of the computer-executable instructions may either be delivered in a tangible physical memory device or transmitted electronically.

Application program modules 140 contain instructions which, when executed by processor(s) 110, cause the processor(s) 110 to render a graphical user interface for user learning on a display device (such as terminal 182). The detail of the learning process and the graphical user interface will be described further below.

Application program modules 140 support other components such as user interaction unit 160 and processing unit 170. The user interaction unit 160 includes receiving means 162, searching means 164, sending means 166 and responding means 168. Processing unit 170 includes analyzing means 172, controlling means 174, recording means 176 and ranking means 178.

The user interaction unit 160 interacts with a user (e.g., 181) through a user terminal (e.g., 182), determines a knowledge point to be studied by the user, determines an information content associated with the knowledge point, and provides the information content to the user through the user terminal.

It is appreciated that the user interaction unit 160 (including receiving means 162, searching means 164, sending means 166 and responding means 168), and the processing unit 170 (including analyzing means 172, controlling means 174, recording means 176 and ranking means 178) may be embodied in any suitable computational components including hardware components and software modules that are able to accomplish the above described receiving, searching, sending, responding, analyzing, controlling, recording and ranking functions. In particular, the software portions of the user interaction unit 160 and the processing unit 170 may be part of the application program(s) 140 stored in storage 130.

In one embodiment, receiving means 162 is used for receiving from the user terminal a user input indicating user selection of a current level knowledge point among the plurality of knowledge points; searching means 164 is used for finding one or more next level knowledge points according to the predefined multilevel arrangement of the knowledge points and/or multiple information sets associated with the respective knowledge points; and sending means 166 is for sending the next level knowledge points to the user terminal. After the user has selected a knowledge point to be studied, searching means 164 may also be used for finding a proper information content associated with the knowledge point and sending the information content to the user terminal 182 to be displayed to the user 182.

The user interaction unit 160 is further adapted to receive from the user an inquiry about user learning history. The responding means 168 of the user interaction unit 160 in this embodiment can be used for generating a response to the inquiry. The response may include a recorded learning history of the user. The recorded learning history can include information of previous learning knowledge points, previous user feedback, and previous study results with respect to the previous learning knowledge point. The user interaction unit 160 may further determine the present knowledge point at least partially based on the recorded learning history of the user. The sending means 166 is used to send the response to the user through the user terminal.

For example, as a returning user logs onto the learning system 100, the user interaction unit 160 may use the recorded learning history of the user to decide the first knowledge point to be studied in the new session. The first knowledge point may be the same as the last knowledge point studied by the user in the last study session. Alternatively, the user interaction unit 160 may decide that the user has finished the last knowledge point in the last study session and therefore the first knowledge point to be studied in a new session should be the next knowledge point progressive from the last knowledge point.

The analyzing means 172 is adapted to evaluate a study result of the user with respect to the present knowledge point. Evaluation is done by analyzing a user feedback entered through the user terminal in response to the information content provided. In addition to being displayed to the user, the evaluation results may be used to determine a next knowledge point to be studied by the user based on the study result.

Recording means 174 is used for recording a learning history of the user. The learning history may include information of the present knowledge point, the user feedback, and the study result.

Data 150 stored in storage 130 may be of any format and structure to accommodate the type of data used in the computer-based learning system 100. For example, the predefined multilevel arrangement of the knowledge points may include one or more of a tree structure, a pyramidal structure, a star structure, a chain structure, a ring structure and a grid structure of the knowledge points. The knowledge points may include preparatory knowledge points associated with at least some of knowledge points. In some embodiments, the multiple information sets in data 150 stored in storage 130 include multiple knowledge contents and multiple evaluation contents which are organized according to respective degrees of difficulty and inter-relationships in view of the predefined multilevel arrangement of the plurality of knowledge points.

In practice, user 181 logs on to learning system 100 through respective client computing device 190 (or any other client computing device 192 or 194), and starts a learning session by selecting a pursuant knowledge point (such as one the user is interested or one that is recommended or selected by learning system 100). Users may be managed using individual user accounts which require a username and password to log on.

In the learning session, the user receives evaluation content associated with the selected knowledge point and provides feedback to learning system 100, which in turn evaluates study result of the user based on the received feedback, and may also determine the next knowledge point according to the predetermined multilevel arrangement of knowledge points and the study result of the user.

The configuration of the learning system is not limited to the particular topology illustrated in FIG. 1. In addition, instead of being hosted on a server, the learning system 100 may be installed in client computing devices (such as personal computers 190 and 192 and even portable devices 194), and optionally updated periodically from a server through the Internet. The functions of a learning system can be implemented by software, hardware or a combination thereof.

An exemplary predefined multilevel arrangement of knowledge points is illustrated below.

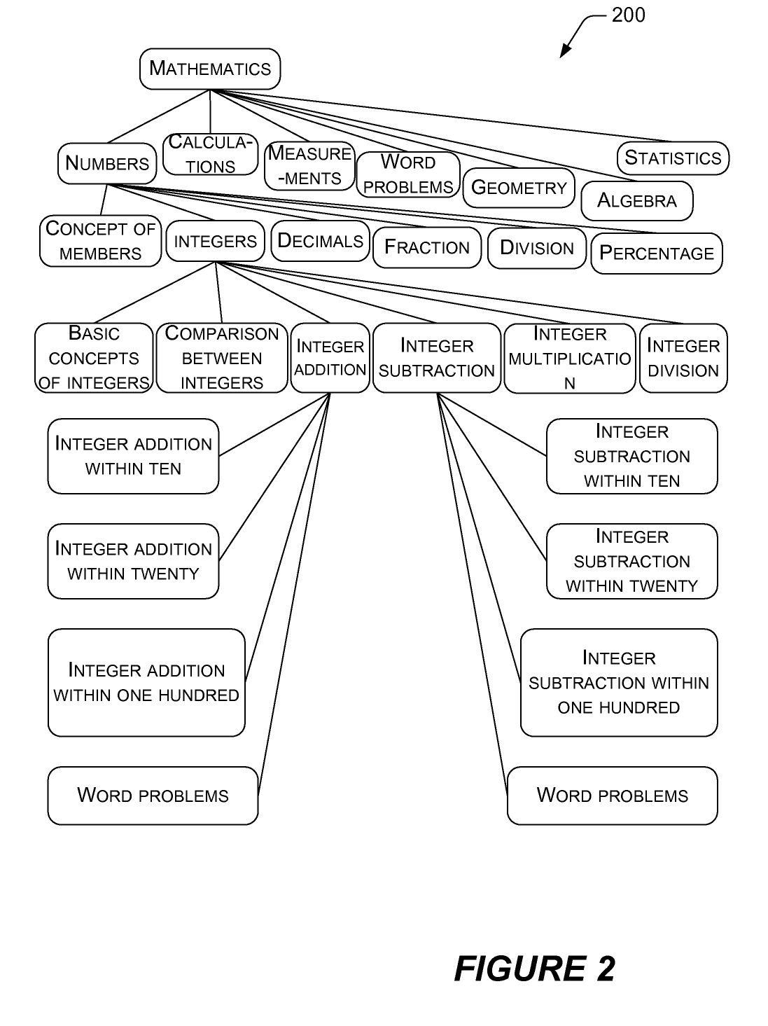

FIG. 2 illustrates an exemplary tree structure of knowledge points in Mathematics in accordance with the learning system of the present disclosure. In the exemplary tree structure 200, the knowledge of Mathematics is differentiated (divided) through multiple levels to the most elemental level at which any further differentiation of the knowledge points would not have a cognitive significance, or no longer help the learning experience of the user. As shown in FIG. 2, the subject of Mathematics is first differentiated into first-level knowledge points—“Numbers”, “Calculations”, “Measurements”, “Word Problems” (or “Applications”), “Geometry” (or “Shapes”), “Algebra”, and “Statistics”. “Numbers” is selected to illustrate the differentiation of the next level. As strong, “Numbers” is then further differentiated into multiple second-level knowledge points, such as “Concept of Numbers”, “Integers”, “Decimals”, “Fractions”, “Division”, “Percentage” and “Ratio and Proportion”. “Integers” is then selected to illustrate the differentiation (division) of the next level. As shown, “Integers” is differentiated into third level knowledge points such as “Basic Concept of Integers”, “Comparison between Integers”, “Integer Addition”, “Integer Subtraction”, “Integer Multiplication” and “Integer Division”. Finally, “Integer Addition” and “Integer Subtraction” are selected to illustrate the lowest level differentiation. Specifically, “Integer Addition” can further be differentiated into fourth level knowledge points—“Addition of Integers within Ten”, “Addition of Integers within Twenty”, “Addition of Integers within One Hundred”, “Word Problems (for addition)”. Similarly, “Integer Subtraction” can further be differentiated into fourth level knowledge points—“Subtraction of Integers within Ten”, “Subtraction of Integers within Twenty”, “Subtraction of Integers within One Hundred”, “Word Problems (for subtraction)”. In the example of FIG. 2, the fourth level knowledge points are the most elemental level knowledge points.

It is appreciated that the use of “first-level knowledge point”, “second-level knowledge point” and so on has no special meaning other than for an illustrative purpose of describing the logical relationship between knowledge points.

The information set of each knowledge point includes knowledge content, evaluation content and solutions for evaluation content. For a non-elemental knowledge point (a knowledge point that has lower level knowledge points), its information set may contain a description of the knowledge point itself and a description of the low level knowledge points related thereto. Such descriptions may be separate descriptions of each knowledge point or a comprehensive description of all related knowledge points. The evaluation content of such a knowledge point may have a set of test questions each addressing a corresponding knowledge point or one or more complex test questions testing multiple related knowledge points within the same question.

### User Interface

In one embodiment, the learning system 100 may be implemented using a website (hosted on a network server, for example) which can be accessed from a user terminal (e.g., any of the client computing devices 190, 192 and 194).

After a user logs into the learning system, a webpage is displayed to the user. The webpage has a graphical user interface. The predefined multilayer arrangement of the knowledge points are navigated through the interactive graphical user interface provided by the webpage. The first-level knowledge points are displayed as a first group of selectable elements in the graphical user interface. The user may choose one of the first-level knowledge points as the present knowledge point to study. The user may also choose the next level knowledge point as the present knowledge point to study. The subsequent levels are manifested to the user as the user navigates through the multilayered structure. Each selected knowledge point is associated with an information set which include knowledge content (teaching materials), evaluation content and solution content. Evaluation content in turn may include several different types such as exercises, tests, and assessments. These different content types of information in the information set associated with each knowledge point are selectable and accessible through content type tabs or links. The user may further select each content type by selecting a content type tab or link. There is no restriction on the order of such selection. The user may alternatively select a content type first and then select a knowledge point to study.

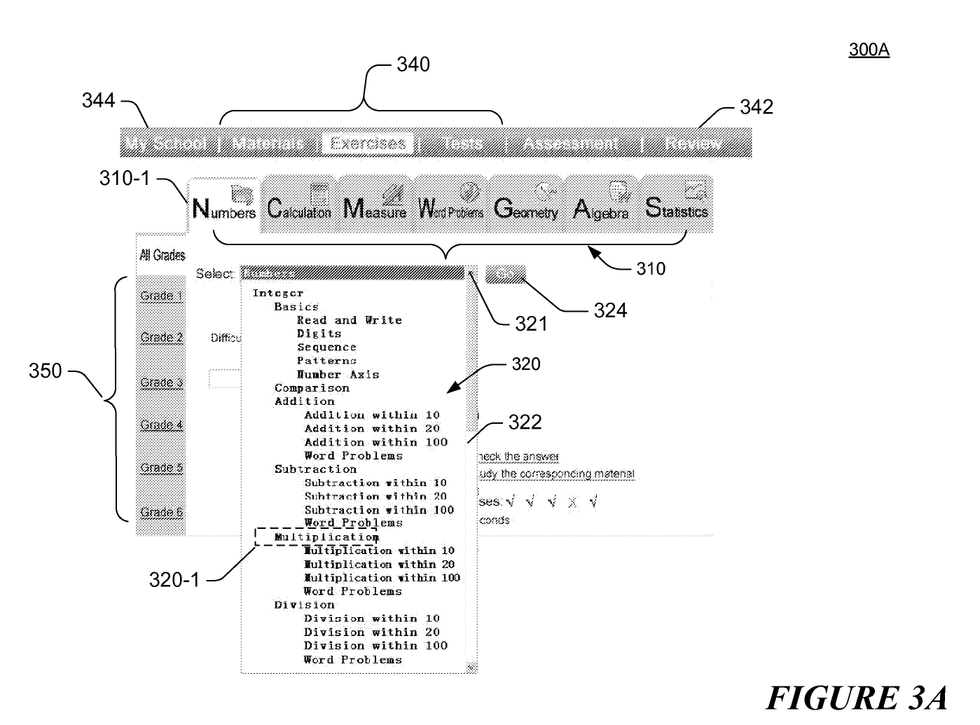

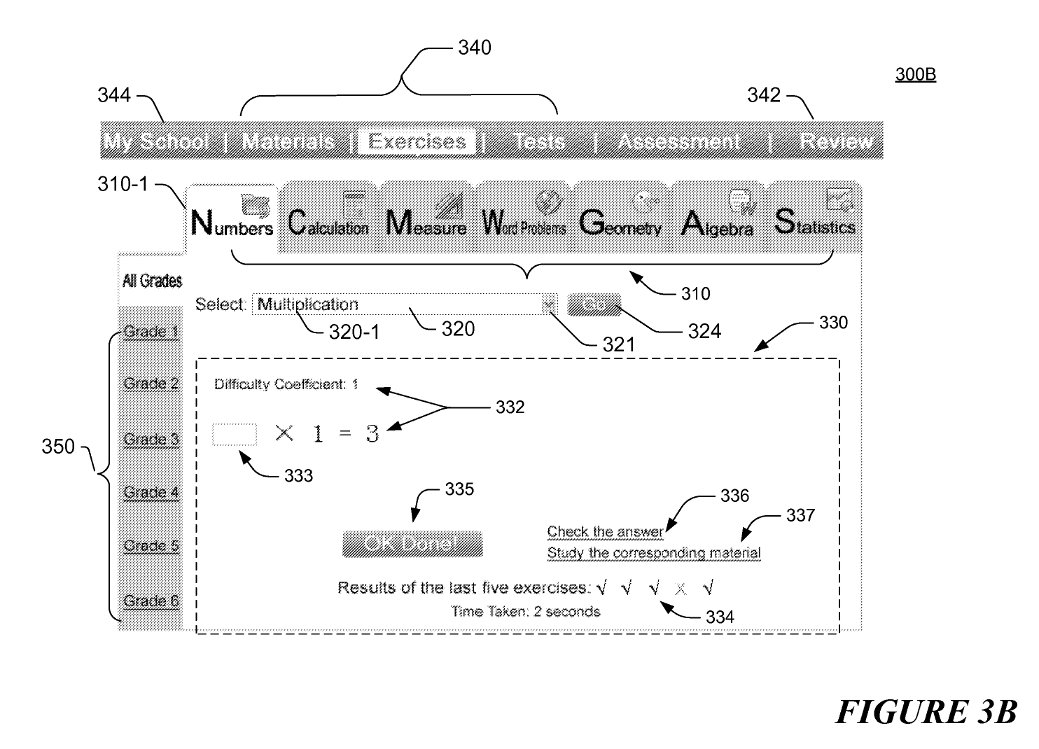

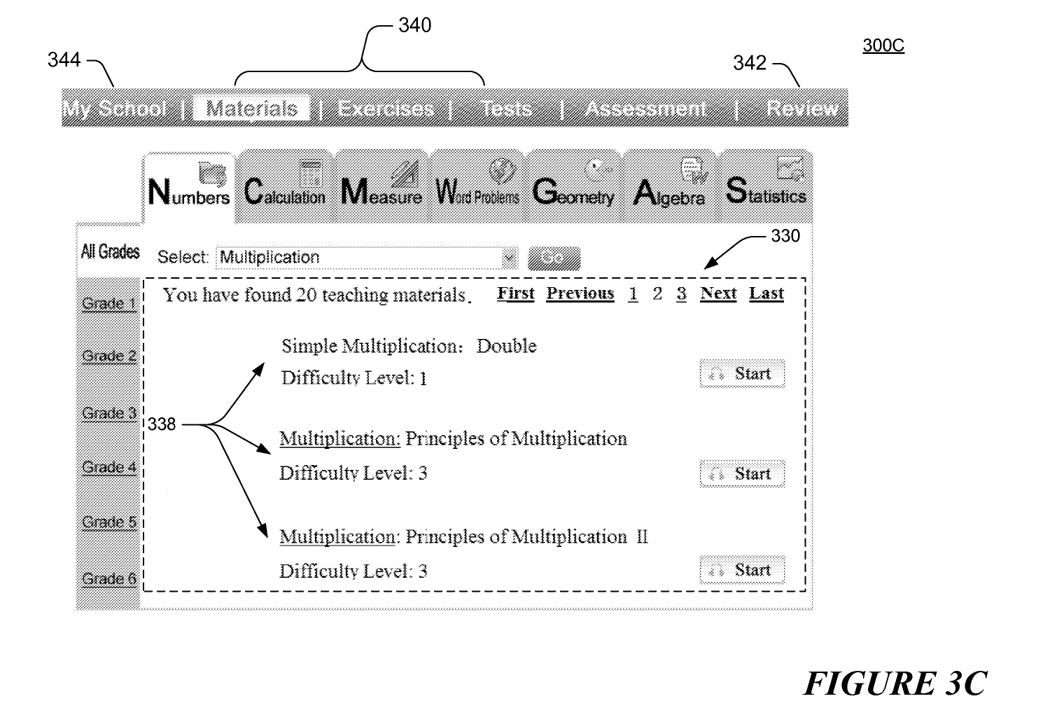

In the following, exemplary graphical user interfaces used in the computer-based learning system are illustrated with reference to several screenshots, FIGS. 3A-3C, FIGS. 4A-4E and FIG. 5.

FIGS. 3A-3C illustrate exemplary primary user interfaces of the above-described learning system. The graphical user interface for user learning has a graphical window 300A renderable by a display device (such as terminal 182 of FIG. 1). The graphical window 300A has a plurality of first-level selectable elements 310 each representing a respective one of a plurality of first-level knowledge points of a learning subject, such as elementary school math as illustrated. As shown, the first-level knowledge points 310 include Numbers, Calculation, Measures, Word Problems, Geometry, and Statistics.

For the purpose of illustration, suppose the user selects “Numbers” as the present first-level knowledge point to be studied. The selection as illustrated may be effectuated by a mouse click or a mouse-over action over the first-level selectable element 310-1 which corresponds to the first-level knowledge point “Numbers”. It is appreciated that any other mouse-equipment devices such as touch-sensitive pen can be used for selecting a selectable element described herein.

A plurality of sublevel selectable elements 320 are invoked by selecting one of the first-level selectable elements 310 (e.g. 310-1). As shown in FIG. 3A, the illustrated sublevel selectable elements 320 are included in a pulldown pick list displayed by clicking at arrow 321. However, sublevel selectable elements 320 may be designed to be displayed automatically when the first-level selectable element 310-1 (or anyone of the first-level selectable elements 310) is selected.

The sublevel selectable elements 320 each represent at least one sublevel knowledge point related to the first-level knowledge point represented by the first-level selectable element currently selected by the user. For example, when the currently selected first-level knowledge point 310-1 is Numbers, the corresponding sublevel selectable elements 320 includes second-level knowledge point “Integer” and others (which can be shown by scrolling down the scrollbar 322), third-level knowledge points under each second-level knowledge point (e.g., Basics, Comparison, Addition, Subtraction, Multiplication, and Division under Integer), and fourth-level knowledge points under each third-level knowledge point (e.g., Multiplication Within Ten, etc. under Multiplication). The sublevel knowledge points are determined based on the currently selected first-level knowledge point 310-1 according to the predefined multilevel arrangement of knowledge points 200 stored in the learning system 100. In the example shown, the fourth-level knowledge points are the most elemental knowledge points. However, it is appreciated that different learning subject may have a different depth of sublevel knowledge points determined by a corresponding predefined multilevel arrangement of knowledge points.

For illustration, suppose in FIG. 3A the user selects sublevel knowledge point “Multiplication” 320-1 as the current knowledge point to be studied. The selection of the current knowledge point to be studied can be effectuated in various ways. The selection may be made by, for example, moving the mouse pointer to the desired knowledge point and clicking on the corresponding selectable element (e.g., “Multiplication” 320-1). Upon the selection, the graphical window 300A may be configured to be automatically updated according to the selection without further user action. Alternatively, the user may need to click on a “Go” button 324 to instruct the learning system to update the graphical window 300A. The learning system updates the graphical window by changing from graphical window 300A to graphical window 300B of FIG. 3B.

As illustrated, graphical window 300B has an information display area 330 to show an information content 332 associated with the currently selected first-level knowledge point 310-1 (Numbers) and sublevel knowledge point 320-1 (Multiplication). The information content 332 is updated automatically upon selection by the user of the current knowledge point to be studied. It is noted that the present knowledge point to be studied does not have to be one of the most elemental knowledge points. Instead, it may be one of the first-level knowledge points or one of the sublevel knowledge points above the most elemental knowledge points.

The information content 332 can be any one or a combination of a knowledge content, an evaluation content or a solution content. In one embodiment, the type of the information content 332 to be displayed in the information display area 330 is determined by another group of selectable elements 340. As illustrated, selectable elements 340 include selectable tabs labeled as “Materials”, “Exercises” and “Tests”. These tabs are used by the user to choose, respectively, teaching materials, exercises and tests as the type of information content to be displayed in the information display area. Teaching materials are a type of knowledge content, while both exercises and tests are each a type of evaluation content. The information content 332 is updated automatically after the user has chosen the type of information via the respective one of the selectable elements (tabs) 340. For example, as illustrated in FIG. 3B, when tab “Exercises” in the selectable elements 340 is chosen, the information content 332 displayed in the information display area 330 is an exercise question. Information content 332 optionally may include other information such as difficult levels of the question.

As illustrated in FIG. 3C, when “Materials” in the selectable elements 340 is chosen, the information content display area 330 is updated to display a new information content 338, which include information of knowledge contents (such as teaching materials) related to the current selected knowledge point “Multiplication” under the first-level knowledge point “Numbers”. The information of each knowledge content may include a title and an indication of the difficulty level of the knowledge content. The title may also serve as a link to the respective knowledge content. Other additional information of each knowledge content, such as an illustrative logo and a brief introduction, may also be included.

Referring back to FIG. 3B, displayed in the information content display area 330 are also user interaction elements 333 and 335 to enter user feedback to the information content 332. In the illustrated example, the information content 332 includes a math question asking what number multiplied by one is equal to three. The user is supposed to provide an answer by typing the number in the text input field (box) 333. Upon entering the member in the text input field 333, the user may click the pushbutton 335 to submit the answer. It is appreciated that other types of user interaction elements such as pick lists and checkboxes may also be used to receive user feedback to the information content (332).

Upon entering the user feedback through the user interaction element, the display area 330 displays an evaluation result 334 of the user feedback entered by the user. The evaluation result 334 may be provided by a server computer in the computer-based learning system (100) substantially via Internet. With sufficient server computing power in the learning system, the evaluation result 334 may be provided instantly. The evaluation result 334 may be a symbol (such as conventional check sign and cross sign) to indicate whether the answer provided by the user is correct or incorrect. In one embodiment, the evaluation result 334 has evaluation results of multiple feedbacks (answers) entered by the user recently to give the user a brief review of his or her visit performance.

In addition to the evaluation result 334 which includes an indication whether the answer is correct, the display area may also display a solution content (not shown) of the evaluation content 332 after the user has submitted an answer. This may be particularly useful especially when the user has submitted an incorrect answer, in which case the user may wish to check the correct answer. The solution content may include not only the correct answer but also explanations of the answer. The solution content may also include multiple answers to the same question, or links to multiple answers to the same question. For example, the solution content may include a standard answer and alternative answer(s) which are either provided by the system or by users. Alternatively or additionally, the solution content may be provided through a separate review user interface, which is described later herein.

Additionally, as illustrated in FIG. 3B, the display area 330 may also display a link 336 to a solution content related to the evaluation content 332 presently displayed, and a link 337 to a teaching material related to an evaluation content 332 presently displayed. User may check the answer of a question or exercise in the evaluation content 332 by following the link 336. If the user feels a need to study the knowledge points before answering the question in the evaluation content 332, the user may visit a teaching material related to the current knowledge point by following the link 337.

As illustrated in FIGS. 3A, 3B and 3C, the graphical window also has another group of selectable elements 350 each to choose a respective grade level of first-level knowledge points and sublevel knowledge points. This is applicable where the predefined multilevel arrangement of the learning system contains multiple groups of first-level knowledge points. This may be the case even for a given subject matter to be studied, such as math, which is studied at different levels in various grades. For example, the knowledge points of each subject matter are grouped into separate groups according to their respective grade level selectable from the selectable elements 350. In FIGS. 3A, 3B and 3C, for instance, the illustrated grade levels are identified as grades as in the traditional school curriculums. The knowledge points of a subject matter, such as math, are grouped into several grades. When the user selects one of the selectable elements 350, e.g., “Grade 1”, the first-level knowledge points 310 may be updated accordingly. A user studies the subject matter at an appropriate grade level, and moves up to the next grade level when the study of the current grade level has been satisfactorily completed. For instance, when the user has finished the group of knowledge points corresponding to the first grade math, the user may start to study the group of knowledge points representing the second grade math by selecting the selectable element “Grade 2” in the selectable elements 350. Such grade promotion may also be done by the learning system automatically based on a diagnosis of the user's learning status.

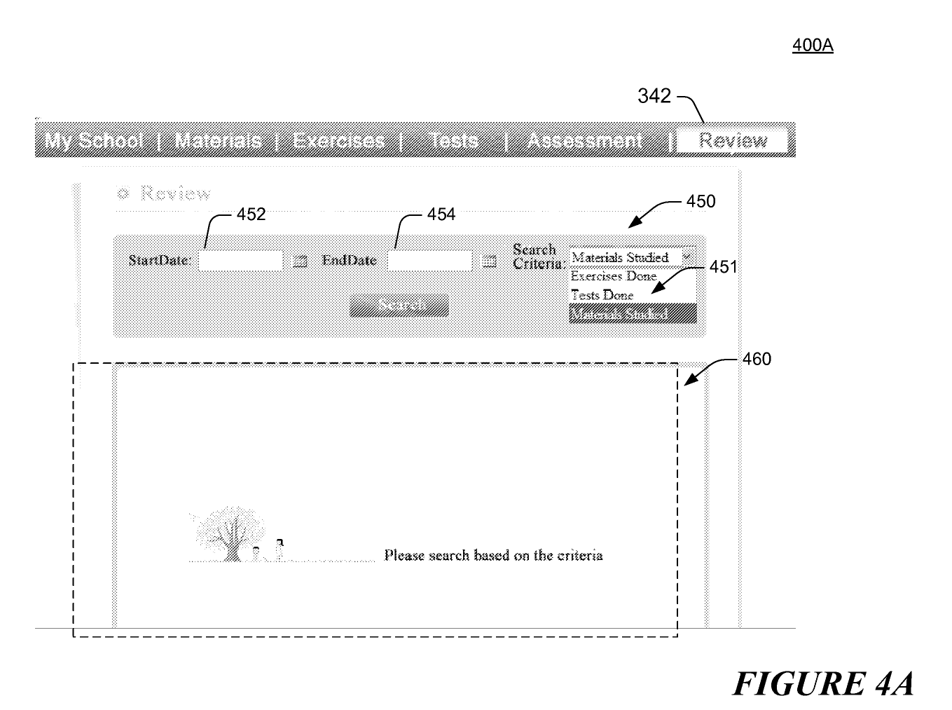

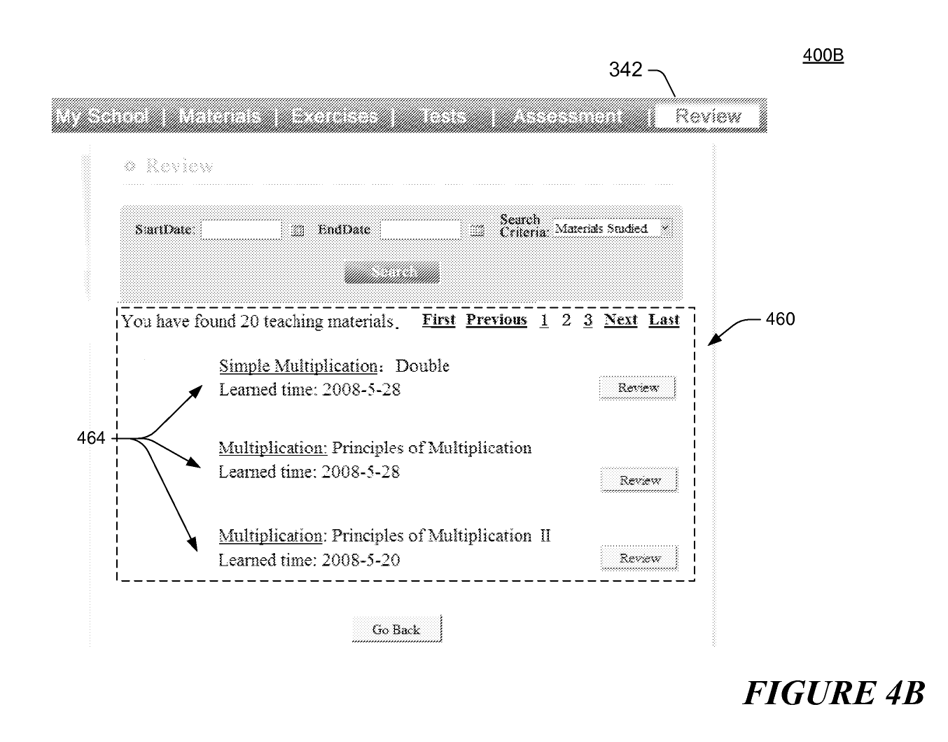

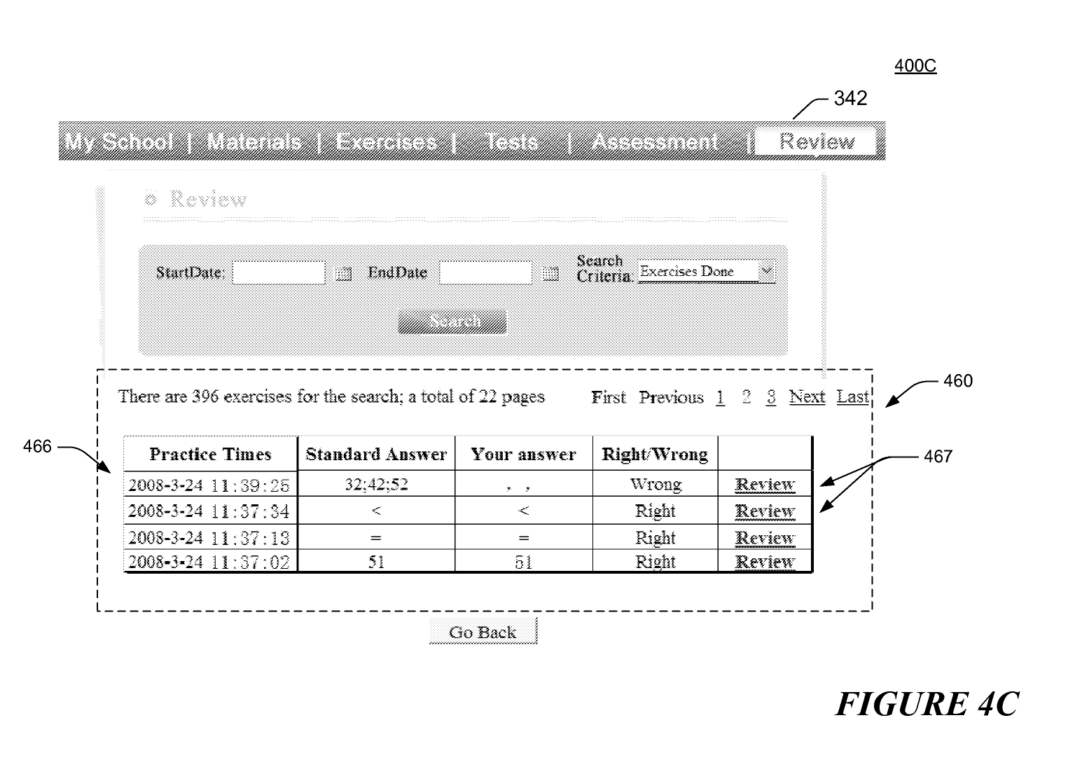

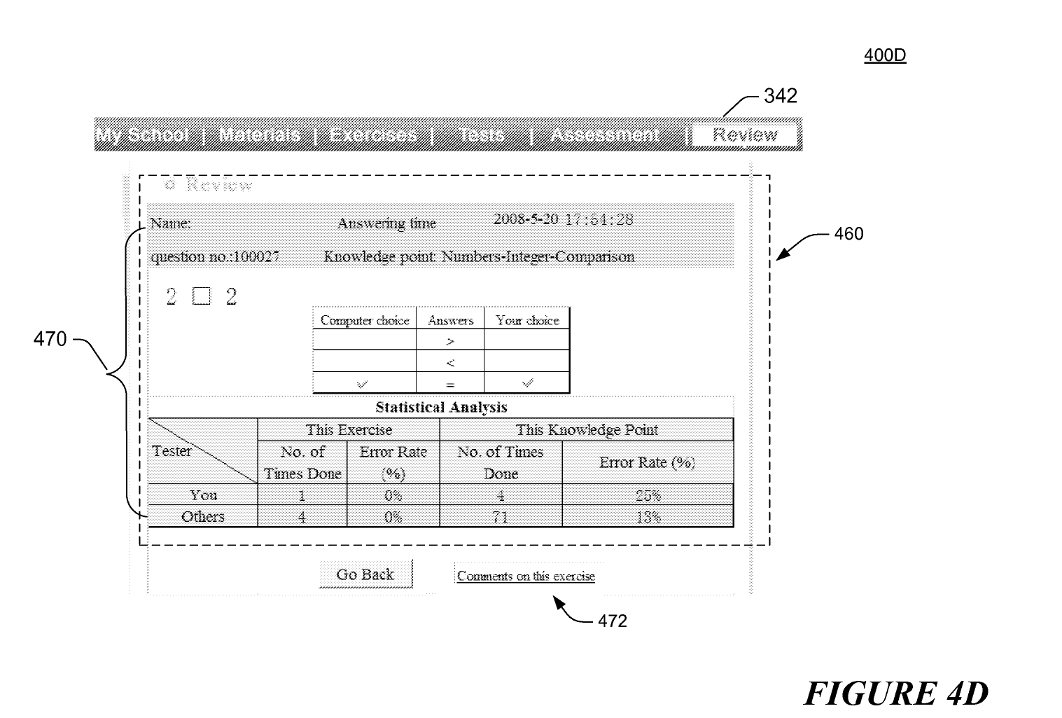

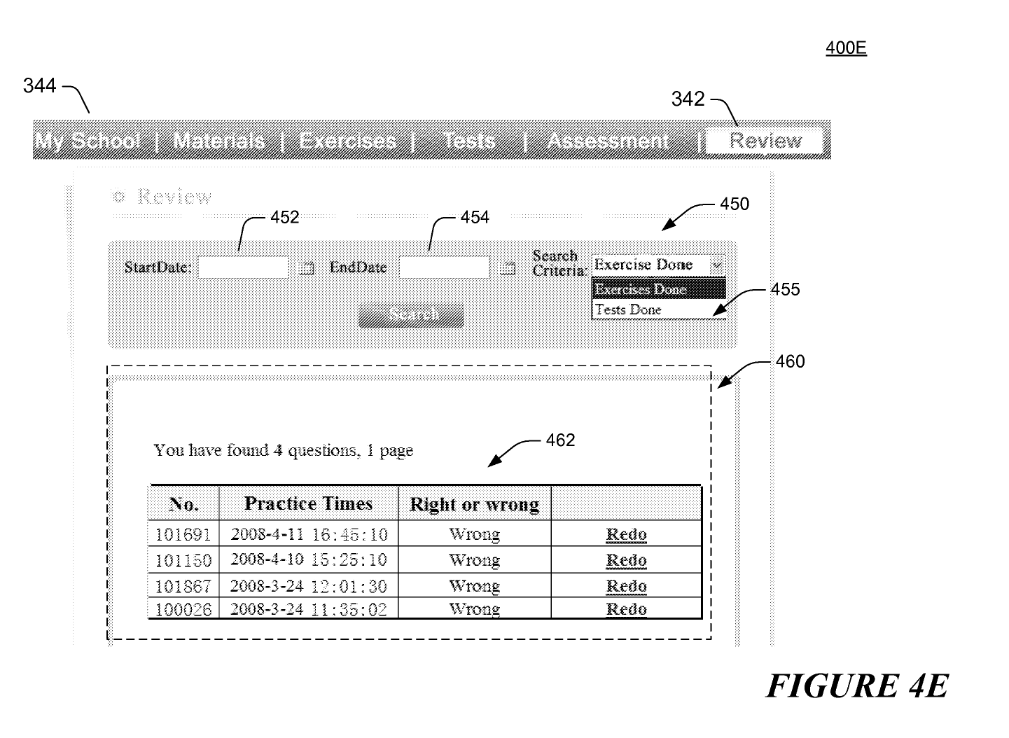

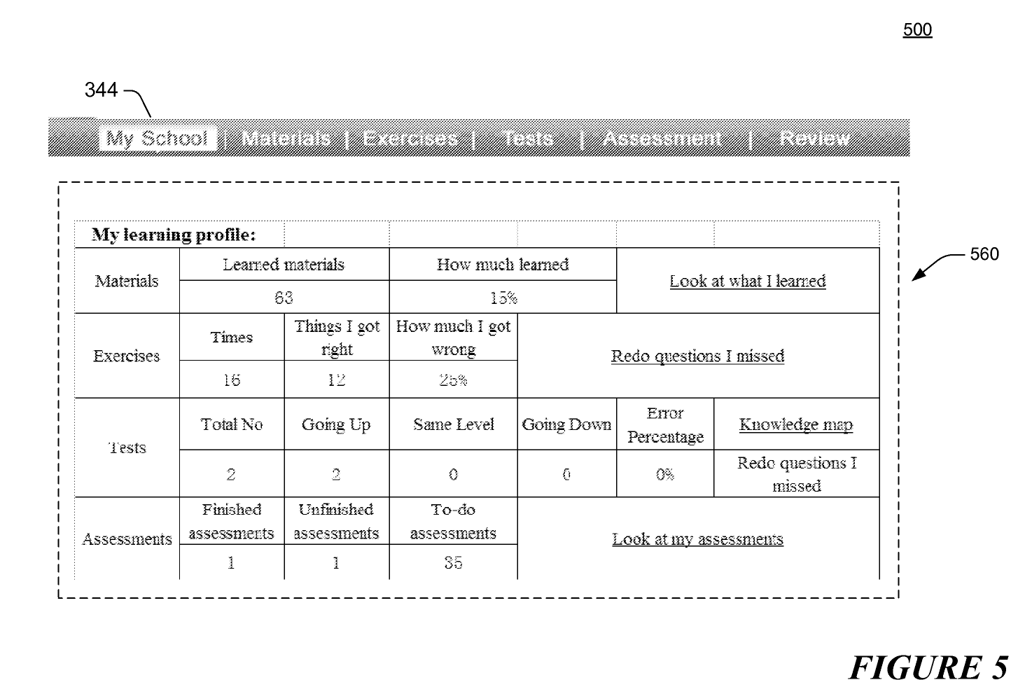

The graphical window 300 (300A, 300B or 300C) further has selectable elements 342 and 344 which provide links to a secondary graphical window for additional user interface. The selectable elements 342 and 344, like selectable elements 340, can each be a clickable button, tab or simple link. The secondary graphical windows are illustrated below with reference to FIGS. 4A-4E and FIG. 5.

FIGS. 4A-4E illustrate exemplary secondary user interfaces of the learning system for user inquiry and user review. Graphical windows 400A, 400B, 400C, 400D and 400E generally appear under selectable element 342 for “review”. These windows may be caused to appear by clicking on selectable element 342 and followed by further user interaction (if necessary). However, these windows may also be caused to appear by following a link contained in other graphical windows (for example, graphical window 500 illustrated herein below). Each graphical window may display different information depending on further user interaction. In general, graphical windows 400A, 400B, 400C, 400D and 400E each have a display area 460 to display history information including statistics on an item. The item may be anyone one of following: a single question, a test having multiple questions, and multiple questions related to one of the first-level knowledge points or one of the sublevel knowledge points. The statistics may include not only the information of the present user, but also comparative information of other users concerning the same item.

Graphical window 400A is used for user inquiry, configured to receive inquiry information from the user through inquiry fields 450, 452 and 454 and to display the result of the inquiry in display area 460. Inquiry field 450 as illustrated has a pulldown pick list 451 for the user to pick from several types of information that can be searched. The illustrated pulldown pick list 451 has three types of information to be selected, namely “Exercises Done”, “Tests Done” and “Materials Studied”, for the user to search, respectively, for exercises, tests and teaching materials which the user has studied in the past. Inquiry fields 452 and 454 are for receiving user input to specify a start date (or time) and an end date defining a search window of time during which the exercises, the tests or the teaching materials have been studied. As illustrated, the present user selection from the pulldown pick list 455 is “Materials Studied”. As the user submit a search, graphical window 400A changes to graphical window 400B as illustrated below.

Graphical window 400B is similar to graphical window 400A, except that a search results 464 is displayed in the display area 460 of graphical window 400B. The illustrated search result 464 is a list of the materials studied by the user. Each entry of a studied material identifies the associated knowledge point and the time learned. A “review” button is also provided with each studied material for the user to review the material. As illustrated, the list of the studied materials in the search results 464 may have multiple pages which can be navigated through the graphical user interface provided by graphical window 400B.

Graphical window 400C is similar to graphical windows 400A and 400B, except that the search results 466 displayed in the display area 460 is a list of the exercises done by the user. Each studied exercise identifies the time of practice, the standard answer (the correct answer provided by the learning system), the user answer, and the evaluation result of the user answer (right or wrong). A “review” or “redo” link 467 (or button) is provided with each exercise for the user to review or redo the exercise. As illustrated, the list of the exercises performed may have multiple pages which can be navigated through the graphical user interface provided by graphical window 400C.

Graphical window 400D is a review window of a particular question or exercise. This window is shown as a result of the user clicking on a “review” link 467 (or button) in graphical window 400C to review a respective exercise. The graphical window 400D displays history information 470 in the display area 460. The history information 470 may include statistics on a particular question, a test having multiple questions, or multiple questions related to a knowledge point. In the example illustrated in graphical window 400D, the history information 470 includes statistics on a particular question identified as “question no.: 10027” which is related to knowledge point “Comparison” under knowledge point “Integer” under the first-level knowledge point “Numbers”. The question is a comparison of two numbers “two” and “two” to determine whether the first number is greater than, smaller than or equal to the second number. The history information 470 displays the system answer called “computer choice” which picks “equal to” as the correct answer. The history information 470 also displays the user answer called “your choice” which also picks “equal to” as the answer, indicating a match between the user answer and the system answer. Furthermore, the history information 470 displays not only statistics of the user concerning the question but also statistics including comparative information of other users concerning the same question. For example, the illustrated history information 470 displays statistics of the question, including the number of times the user has done this question, the error rate of the user for this question, the number of times other users have done this question, and the error rate of other users for this question. In addition, the history information 470 may also include similar statistics of all questions related the same knowledge point.

Additionally, the graphical window 400D also provides a link 472 for the user to comment on the question or exercise. This allows the learning system to receive further feedback from the user concerning the question or exercise, such as the quality of the question, and the quality of the answer (especially if the system answer provided is incorrect). Users may even provide alternative answers to the question or suggest a better question or exercise addressing the same knowledge point.

Graphical window 400E is a variation of graphical window 400A used for user inquiry. Unlike graphical window 400A which is for a broader search, graphical window 400E is limited to questions, exercises or tests which the user missed or had shown difficulties in understanding or answering. These questions are listed in query result 462 displayed in the display area 460. The query result 462 may be further quantified by other parameters such as user selections (e.g., the current knowledge point to be studied). Graphical window 400 may be accessible under selectable element (tab) 342 for “Review”, or under selectable element (tab) 344 for “My School”, which is a summary page for user profile information and is illustrated below with reference to FIG. 5.

Graphical window 400E is configured to receive inquiry information from the user through inquiry fields 450, 452 and 454 and to display the query result 462 in display area 460. Inquiry field 450 as illustrated has a pulldown pick list 455 for the user to pick from several types of information that can be searched. The illustrated pulldown pick list 455 has two types of information to be selected, namely “Exercises Done” and “Tests Done”, for the user to search, respectively, from exercises and tests. Inquiry fields 452 and 454 are for receiving user input to specify a start date and an end date defining a search window of time during which the exercises or the tests have been studied. As illustrated, the present user selection from the pulldown pick list 455 is “Exercises Studied”.

FIG. 5 illustrates an exemplary secondary user interface of the learning system for demonstrating a user learning profile. Graphical window 500 appears under selectable element 344 for “My School”. This window may be caused to appear by clicking on selectable element 344. The illustrated user learning profile displayed in the display area 560 includes tabulated information showing user performance in each of the sections such as materials, exercises, tests and assessments. Graphical window 500 may also display, along with the user learning profile, links to further user actions, such as to look at what materials the user has learned, to redo questions the user has missed, to view a knowledge point map associated with a second test, and to look at the assessments the user has conducted. For example, the link “Redo Questions I Missed” leads the user to graphical window 400E illustrated above in FIG. 4E which displays a list of questions the user missed (e.g., query result 462).

The graphical user interface described herein can be used in the learning system 100 and the learning system described in U.S. patent application Ser. No. 12/121,249, filed on May 15, 2008, entitled “Differentiated, Integrated and Individualized Education”. It is appreciated that the features of the learning system described in that U.S. patent application may be incorporated into the graphical user interface described herein.

For example, the knowledge points selectable in the user interface and the associated information content displayed in the information display area may be individualized, as discussed below.

To individualize knowledge points displayed in the graphical window, knowledge points of a subject matter are grouped into separate groups according to, for example, their respective levels of difficulty. The user or the learning system chooses a group of knowledge points to be studied that has a suitable or desirable difficulty level. The learning system may make such a choice based on the predefined multilevel arrangement of the knowledge points and a user input. The group of knowledge points may be a portion or all of the knowledge points in the predefined multilevel arrangement. After such a selection is made for a particular user, the selected group of knowledge points, including both the first-level knowledge points and sublevel knowledge points, are displayed in the graphical window to the user during learning sessions. This further individualizes the study by defining different groups of knowledge points to be studied by different users. For example, when a new user uses the learning system for the first time, the learning system may collect user information such as age, gender, school, grade, class, geographic location, and parental information such as occupation, age, and education of the parent(s) if the user is a young student. Using such information, the learning system may decide which group of knowledge points to start with for the new user. After the user has used the learning system for some time, the learning system will have accumulated a learning history of the user containing past study results and feedback speed information, and may use such history information to further define or adjust the group of knowledge points suited for the particular user's study.

To determine a group of knowledge points for a user, the learning system may also provide an initial test to the user and receive feedback from the user to the test questions. The learning system analyzes the received feedback and determines the level of knowledge of the user for the purpose of defining a group of knowledge points to be studied.

To individualize the information content displayed in the user interface, the information set associated with each knowledge point may have information contents in multiple versions representing various learning levels and/or teaching styles. The multiple-versioned information content may change from one version to another with respect to knowledge content, evaluation content or solution content. The learning system determines which version of the information set is to be provided to the user based on the user feedback and other user preferences. For example, with several versions of information set each representing a different level of difficulties, the learning system determines which level of difficulty is to be provided to the user for the study of the present knowledge point and/or the next knowledge point. For instance, the information set may have three different versions, namely advanced, medium, and basic. If the study result of the user for the present knowledge point is excellent, the level of difficulty for the next knowledge point may be determined as “advanced”. Upon directing the user to the next knowledge point, the learning system provides the advanced version of the information set of the knowledge point. If the study result of the present knowledge point is good but not excellent, the level of difficulty for the next knowledge point may be determined as “medium”, and so on. The design of the different versions and the selection thereof will depend on the specific requirements, policies and styles of the learning system and also user preferences. The selection of the level of difficulty may be made automatically by the learning system or left to the user to make. In particular, the level of the difficulty of the first knowledge point to be studied can be made by the user, randomly selected by the system, or determined by a preset user preference.

The above described user interface may be rendered using the learning system 100 with an exemplary process illustrated below.

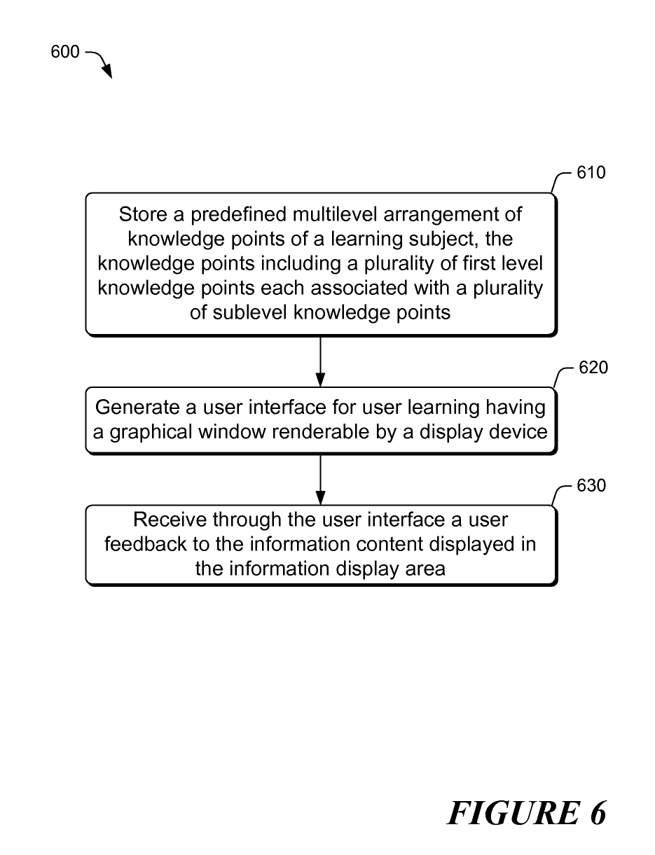

FIG. 6 is a flowchart of an exemplary method using the learning system to render the user interface and to provide user learning. This flowchart should be understood with reference to FIGS. 1-4. In this description, the order in which a process is described is not intended to be construed as a limitation, and any number of the described process blocks may be combined in any order to implement the method, or an alternate method.

At block 610, the learning system (100) stores a predefined multilevel arrangement of knowledge points (200) of a learning subject. The knowledge points include a plurality of first-level knowledge points each associated with a plurality of sublevel knowledge points as illustrated above.

At block 620, the learning system (100) generates a user interface for user learning having a graphical window (e.g., 300) renderable by a display device (e.g., 190, 182). The user selects through the user interface a present knowledge point to be studied. The user may further select the type of information content associated with the present knowledge point to be provided by the learning system. The learning system sends the appropriate information content based on the user selection to be displayed in an information display area (330) in a graphical window of the user interface.

At block 630, the learning system (100) receives through the user interface a user feedback to the information content displayed in the information display area.

User feedback can be any relevant information collected by the learning system during the user response to the information associated with one or more knowledge points presented to the user by the learning system. Examples of such information include user answers to the questions, speed of response, and the level of completion.

Based on the user feedback, the learning system evaluates the study result of the user. The study process continues from this point through further user-system interaction, in accordance with the present description.

It is appreciated that the potential benefits and advantages discussed herein are not to be construed as a limitation or restriction to the scope of the appended claims.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A graphical user interface for user learning having a graphical window renderable by a display device, the graphical window comprising:
a plurality of first-level selectable elements each representing a respective one of a plurality of first-level knowledge points of a learning subject;
a plurality of sublevel selectable elements invoked by selecting one of the first-level selectable elements, the plurality of sublevel selectable elements each representing at least one sublevel knowledge point related to the first-level knowledge point represented by the first-level selectable element currently selected by a user, the at least one sublevel knowledge point being determined based on the first-level knowledge point according to a predefined multilevel arrangement of knowledge points; and
an information display area to show an information content associated with the currently selected first-level knowledge point and sublevel knowledge point.

2. The graphical user interface as recited in claim 1, wherein the plurality of sublevel selectable elements comprises:
a second-level selectable element and a third-level selectable element, wherein the second-level selectable element represents a second-level knowledge point related to the first-level knowledge point currently selected by the user, and the third-level selectable element represents a third-level knowledge point related to the second-level knowledge point, the third-level knowledge point being determined based on the second-level knowledge point and the first-level knowledge point according to the predefined multilevel arrangement of knowledge points.

3. The graphical user interface as recited in claim 1, wherein the plurality of sublevel selectable elements comprises a pulldown pick list listing the sublevel knowledge points related to the presently selected first-level knowledge point according to the predefined multilevel arrangement of knowledge points.

4. The graphical user interface as recited in claim 1, wherein the selecting of the one of the first-level selectable element is effectuated by a mouse click or a mouse-over action.

5. The graphical user interface as recited in claim 1, wherein the information content has at least one of a knowledge content, an evaluation content or a solution content.

6. The graphical user interface as recited in claim 1, wherein the graphical window further comprises a user interaction element to enter user feedback to the information content displayed in the information display area.

7. The graphical user interface as recited in claim 6, wherein the user interaction element comprises at least one of a text input field, a pick list, a pushbutton and a checkbox.

8. The graphical user interface as recited in claim 6, wherein upon entering the user feedback through the user interaction element, the display area displays an evaluation result of the user feedback entered by the user.

9. The graphical user interface as recited in claim 8, wherein the evaluation result is provided by a server computer substantially instantly.

10. The graphical user interface as recited in claim 1, wherein the display area is also adapted to display a link to a solution content related to an evaluation content presently displayed in the display area.

11. The graphical user interface as recited in claim 10, wherein the display area is also adapted to display a link to a knowledge content related to an evaluation content presently displayed in the display area.

12. The graphical user interface as recited in claim 1, wherein the display area is further used to display an evaluation result of a user feedback entered by the user.

13. The graphical user interface as recited in claim 1, wherein the display area is further used to display evaluation results of multiple feedbacks entered by the user recently.

14. The graphical user interface as recited in claim 1, wherein the information content is updated automatically upon selection by the user of the first-level knowledge point and the sublevel knowledge point.

15. The graphical user interface as recited in claim 1, wherein the information content is provided by a server to the display device via Internet.

16. The graphical user interface as recited in claim 1, wherein the graphical window further comprises:
a plurality of second type selectable elements each to choose a respective type of information content to be displayed in the information display area.

17. The graphical user interface as recited in claim 16, wherein the plurality of second type selectable elements includes:
a first of the second type selectable element to choose teaching material as the type of information content to be displayed in the information display area;
a second of the second type selectable element to choose exercises as the type of information content to be displayed in the information display area; and
a third of the second type selectable element to choose tests as the type of information content to be displayed in the information display area.

18. The graphical user interface as recited in claim 16, wherein the information content is updated automatically after the user has chosen the type of information via the respective one of the second type selectable elements.

19. The graphical user interface as recited in claim 1, wherein the graphical window further comprises:
a plurality of third type selectable elements each to choose a respective grade level of first-level knowledge points and sublevel knowledge points.

20. The graphical user interface as recited in claim 1, wherein the graphical window further comprises a link to a second graphical window used for user inquiry, the second graphical window being configured to receive inquiry information from the user and display result of the inquiry.

21. The graphical user interface as recited in claim 20, wherein the second graphical window used for user inquiry contains inquiry fields for user selection and/or user input to define a user inquiry, the inquiry fields including a first inquiry field to specify a time and a second inquiry field to specify a type of information inquired in the user inquiry.

22. The graphical user interface as recited in claim 1, wherein the graphical window further comprises a link to a second graphical window used for performing user review of past learning, the second graphical window being configured to display history information including statistics on an item, the item comprising at least one of following: a single question, a test having multiple questions, and multiple questions related to one of the first-level knowledge points or one of the sublevel knowledge points.

23. The graphical user interface as recited in claim 22, wherein the statistics include comparative information of other users concerning the same item.

24. The graphical user interface as recited in claim 22, wherein the second graphical window includes means for user to enter a comment of the item.

25. A computer implemented learning method comprising:
storing a predefined multilevel arrangement of knowledge points of a learning subject, the knowledge points including a plurality of first-level knowledge points each associated with a plurality of sublevel knowledge points;
generating a user interface for user learning having a graphical window renderable by a display device, the graphical window including:
a plurality of first-level selectable elements each representing a respective one of the plurality of first-level knowledge points,
a plurality of sublevel selectable elements invoked by selecting one of the first-level selectable elements, the plurality of sublevel selectable elements each representing at least one sublevel knowledge point related to the first-level knowledge point represented by the first-level selectable element currently selected by a user, the at least one sublevel knowledge point being determined based on the first-level knowledge point according to the predefined multilevel arrangement of knowledge points, and
an information display area to show an information content associated with the currently selected first-level knowledge point and the at least one sublevel knowledge point; and
receiving through the user interface a user feedback to the information content displayed in the information display area.

26. The computer implemented learning method as recited in claim 25, further comprising:
displaying through the user interface an evaluation result of the user feedback entered by the user.

27. A computer-based learning system comprising:
a processing unit; and
a storage including computer program instructions executable by the processor unit to render a graphical user interface for user learning having a graphical window on a display device, wherein the graphical window comprises:
a plurality of first-level selectable elements each representing a respective one of the plurality of first-level knowledge points,
a plurality of sublevel selectable elements invoked by selecting one of the first-level selectable elements, the plurality of sublevel selectable elements each representing at least one sublevel knowledge point related to the first-level knowledge point represented by the first-level selectable element currently selected by a user, the at least one sublevel knowledge point being determined based on the first-level knowledge point according to the predefined multilevel arrangement of knowledge points, and
an information display area to show an information content associated with the currently selected first-level knowledge point and the at least one sublevel knowledge point.
